(19) United States
(12) Patent Application Publication
(10) Pub. No.: US 2023/0125338 A1
(43) Pub. Date: Apr. 27, 2023

(54) METHOD FOR PREPARING CORE-SHELL STRUCTURE PHOTOCATALYTIC MATERIAL BY PRECIPITATION AND SELF-ASSEMBLY PROCESS

(71) Applicants: Yunnan Huapu quantum Material Co., Ltd, Kunming (CN); Chongqing Institute of East China Normal University, Chongqing (CN); East China Normal University, Shanghai (CN); ROI Optoelectronics Technology CO, LTD., Shanghai (CN); Chongqing Huapu Quantum Technology Co.,Ltd., Chongqing (CN); Chongqing Huapu Environmental Protection Technology Co., Ltd., Chongqing (CN); Chongqing Menghe Biotechnology Co., Ltd., Chongqing (CN)

(72) Inventors: Heping ZENG, Chongqing (CN); Mengyun HU, Chongqing (CN)

(21) Appl. No.: 18/046,185

(22) Filed: Oct. 13, 2022

(30) Foreign Application Priority Data
Oct. 14, 2021 (CN) 202111195631.X

(51) Int. Cl. B01J 21/06; B01J 21/18; B01J 29/06; B01J 21/16; B01J 35/00; B01J 35/10; B01J 37/04; B01J 37/03; B01J 37/02; B01J 37/00; B01J 37/06; B01J 37/08

(52) U.S. Cl. CPC B01J 21/063; B01J 21/18; B01J 29/06; B01J 21/16; B01J 35/0013; B01J 35/006; B01J 35/1057; B01J 35/1061; B01J 35/1019; B01J 35/1023; B01J 35/1038; B01J 35/1042; B01J 35/1047; B01J 35/004; B01J 37/04; B01J 37/035; B01J 37/0236; B01J 37/009; B01J 37/06; B01J 37/088

(57) ABSTRACT

A method for preparing a core-shell structure photocatalytic material includes: obtaining a titanyl sulfate solution by mixing and reacting sulfuric acid and metatitanic acid; obtaining a mixed solution by adding a porous material having a hydrophilic surface into the titanyl sulfate solution; adding an alkali into the mixed solution to obtain a precipitation product by reacting the alkali with the titanyl sulfate coated on the surface of the porous material; and filtering, washing, drying and calcining the precipitation product to obtaining a core-shell structure photocatalytic material with the porous material as a core and a mesoporous quantum titanium oxide as a shell.

### CROSS-REFERENCE TO RELATED APPLICATION

This application claims priority to Chinese Patent Application Serial No. 202111195631.X, filed on Oct. 14, 2021, the entire disclosure of which is incorporated herein by reference.

### FIELD

The present disclosure relates to a field of photocatalytic material preparation, and more particularly to a method for preparing core-shell structure photocatalytic material by a precipitation and self-assembly process.

### BACKGROUND

In recent decades, titanium dioxide (TiO₂) materials have attracted attention due to their electro-optical properties, such as strong oxidizing ability, small band gap (3.2 eV), low cost, high chemical inertness, and photostability. The titanium dioxide materials have been developed for a variety of environmental materials, such as solar cells, photocatalytic materials, and gas sensor. There is an effort to design and fabricate a variety of nanostructures of TiO₂, such as films, nanorods, hollow microspheres, spherical particles, and nanotubes, so as to enhance properties of TiO₂. In these materials, porous titanium is considered as a promising material for air purification and water purification. Common methods for preparing porous photocatalytic materials include a soft template method, a hard template method, and a polymer/silica gel method, and these methods generally need complicated steps, strong acid corrosion, high-temperature carbonization or addition of a large amount of organic solvent, which seriously hinder industrialization of mesoporous materials.

### SUMMARY

The present disclosure provides a method for preparing a core-shell structure photocatalytic material, including:

obtaining a titanyl sulfate solution by mixing and reacting sulfuric acid and metatitanic acid, in which the metatitanic acid is used as a titanium source, and a first reaction formula is indicated by:

H₂TiO₃+H₂SO₄→TiOSO₄+2H₂O;

obtaining a mixed solution by adding a porous material into the titanyl sulfate solution, in which the porous material has a hydrophilic surface to allow the titanyl sulfate solution to diffuse into pores of the porous material to obtain a porous composite material coated with the titanyl sulfate, and a second reaction formula is indicated by:

TiOSO₄+porous material→titanyl sulfate porous composite material;

adding an alkali into the mixed solution to obtain a precipitation product by reacting the alkali with the titanyl sulfate coated on the surface of the porous material, in which a third reaction formula is indicated by:

TiOSO₄+alkali→TiO(OH)₂↓+sulfate;

filtering, washing, drying and calcining the precipitation product to obtaining a core-shell structure photocatalytic material with the porous material as a core and a mesoporous quantum titanium oxide as a shell, in which a fourth reaction formula is indicated by:

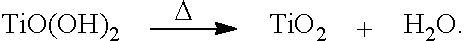

### BRIEF DESCRIPTION OF THE DRAWINGS

FIG. 1 is a scanning electron microscope image of a photocatalytic material with a zeolite powder core and a titanium oxide shell;

FIG. 2 is a scanning electron microscope image of a photocatalytic material with a graphene core and a titanium oxide shell;

FIG. 3 is a schematic diagram showing a visible-light driven photocatalytic activity of a photocatalytic material with a graphene core and a titanium oxide shell;

FIG. 4 is a schematic diagram showing a visible-light driven photocatalytic stability of a photocatalytic material with a graphene core and a titanium oxide shell; and

FIG. 5 is a schematic diagram showing a method for preparing a shell-core structure photocatalytic material.

### DETAILED DESCRIPTION

Embodiments of the present disclosure seek to solve at least one of the problems existing in the related art to at least some extent.

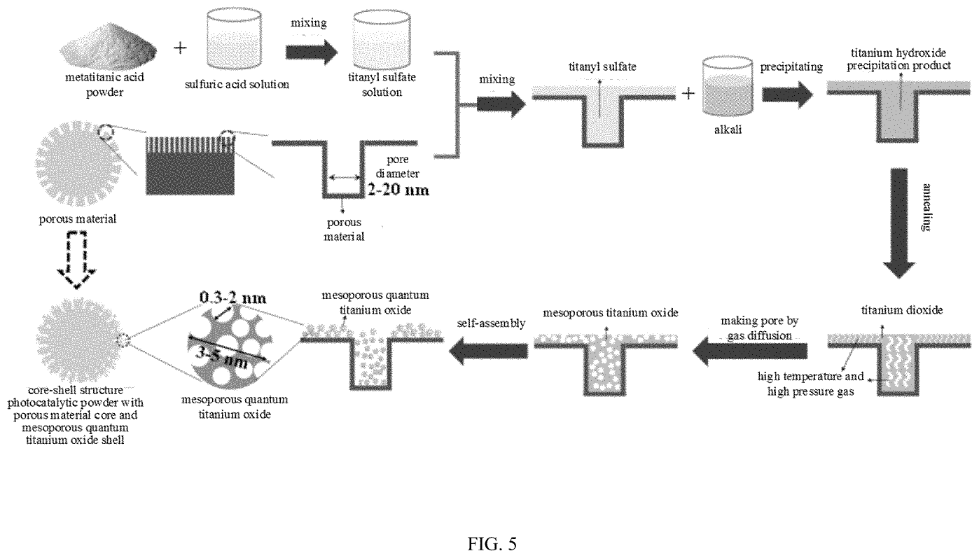

Accordingly, the present disclosure provides a method for preparing a core-shell structure photocatalytic material, as shown in FIG. 5, including: obtaining a titanyl sulfate solution by mixing and reacting sulfuric acid and metatitanic acid, in which the metatitanic acid is used as a titanium source, and a first reaction formula is indicated by:

H₂TiO₃+H₂SO₄→TiOSO₄+2H₂O;

obtaining a mixed solution by adding a porous material into the titanyl sulfate solution, in which the porous material has a hydrophilic surface to allow the titanyl sulfate solution to diffuse into pores of the porous material to obtain a porous composite material coated with the titanyl sulfate, and a second reaction formula is indicated by:

TiOSO₄+porous material→titanyl sulfate porous composite material;

adding an alkali into the mixed solution to obtain a precipitation product by reacting the alkali with the titanyl sulfate coated on the surface of the porous material, in which a third reaction formula is indicated by:

TiOSO₄+alkali→TiO(OH)₂↓+sulfate;

filtering, washing, drying and calcining the precipitation product to obtaining a core-shell structure photocatalytic material with the porous material as a core and a mesoporous quantum titanium oxide as a shell, in which a fourth reaction formula is indicated by:

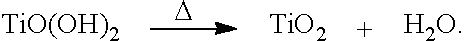

In the present disclosure, the photocatalytic material is prepared by a precipitation and self-assembly process. That is, the alkali is added to make the alkali diffuse into the pores of the porous material and react with the titanyl sulfate to generate titanium hydroxide. The titanium hydroxide is annealed at a high temperature to generate the mesoporous quantum titanium oxide. When the precipitate is heated to this high temperature, a gas with a high temperature and a high pressure is formed inside the porous material and flows from inside to outside. With the flow of the high temperature and pressure gas, the mesoporous quantum titanium oxide grows from inside of the porous material to outside, and a mesoporous quantum titanium oxide shell is formed on the surface of the porous material to realize self-assembly of the mesoporous quantum titanium oxide. In other words, the porous material is coated with the mesoporous quantum titanium oxide, and thus the porous material is the core and the titanium oxide is the shell.

In some embodiments, the metatitanic acid is from a raw material having a mass fraction of the metatitanic acid in a range of 40% to 50%, and has a relative molecular mass of 97.92.

In some embodiments, the sulfuric acid has a density of 1.84 g/mL, and a relative molecular mass of 98.

In some embodiments, a molar mass ratio of the metatitanic acid to the sulfuric acid is in a range of 1:1 to 1:10.

In some embodiments, a mixing time of the metatitanic acid and the sulfuric acid is in a range of 0.1 to 24 hours.

In some embodiments, a mass ratio of the titanyl sulfate to the porous material is in a range of 1:1 to 1:1000.

In some embodiments, a mixing time of the titanyl sulfate and the porous material is in a range of 0.1 to 24 hours.

In some embodiments, a diffusion depth of the titanyl sulfate in the porous material is in a range of 1 to 2 μm.

In some embodiments, the titanyl sulfate diffuses into the porous material at a temperature of 80 to 400° C. with a heating rate of 2 to 10° C./min, and at a pressure of 0 to 30 bar.

In some embodiments, a mass ratio of the alkali to the titanyl sulfate is in a range of 1:1 to 1:10, and a mixing time of the titanyl sulfate and the alkali is in a range of 0.1 to 24 hours.

In some embodiments, the alkali is selected from ammonia water, sodium hydroxide, calcium hydroxide, potassium hydroxide, sodium bicarbonate, sodium carbonate, zinc hydroxide, aluminum hydroxide, ferric hydroxide, ferrous hydroxide, magnesium hydroxide, cobalt hydroxide, gold hydroxide, copper hydroxide, beryllium hydroxide, and a combination thereof.

In some embodiments, the porous material is selected from zeolite powders, molecular sieve, activated carbon, porous aluminum oxide, mesoporous silicon oxide, mesoporous carbon, mesoporous silicon, carbon black, attapulgite, bentonite, diatomaceous earth, three-dimensional graphene, metal organic framework materials, covalent organic framework materials, two-dimensional metal carbides or nitrides, and a combination thereof.

In some embodiments, the porous material has a pore diameter of 2 to 20 nm, a surface contact angle not greater than 30°, a specific surface area not less than 150 m²/g and a pore volume not less than 0.1 cm³/g.

In some embodiments, the mesoporous quantum titanium oxide is generated during the precipitation and self-assembly process (i.e., the calcining/heating/annealing process) at a temperature of 60 to 1200° C. with a heating rate of 2 to 20° C./min. For example, the temperature is in a range of 300 to 800° C. or 400 to 600° C.

In some embodiments, the mesoporous quantum titanium oxide is a titanium oxide nanoparticle with a size of 1 to 10 nm, and has a porous structure with a pore diameter of 0.1 to 2 nm.

In some embodiments, the annealing is performed for 0.5 to 48 hours.

In some embodiments, the mesoporous quantum titanium oxide has a specific surface area in a range of 150 to 300 m²/g.

In some embodiments, the mesoporous quantum titanium oxide has a crystal type selected from anatase, rutile, and rutile-doped anatase.

In some embodiments, the mesoporous quantum titanium oxide has a size in a range of 3 to 5 nm, a pore diameter in a range of 0.3 to 2 nm.

In some embodiments, the photocatalytic material has a specific surface area of 100 to 600 m²/g (e.g., 200 to 300 m²/g), a pore diameter in a range of 1 to 3 nm, and a pore volume of 0.1 to 2 cm³/g.

According to the method in the present disclosure, the metatitanic acid raw material is used as the titanium source, and the sulfuric acid and the metatitanic acid are mixed to obtain the titanyl sulfate solution. The porous material is added into the titanyl sulfate solution to obtain the mixed solution, and the alkali is added into the mixed solution to obtain the titanium hydroxide precipitation product. By performing filtering, washing, drying and calcining the precipitation product, the core-shell structure photocatalytic material with the porous material core and the mesoporous quantum titanium oxide shell is obtained. Parameters (such as specific surface area, pore volume, and crystallinity of the resulting photocatalytic material with the porous framework core and the titanium oxide shell may be controlled by adjusting reaction parameters such as reaction time, temperature and precursor concentration of the reactions. In this way, the present method can be used to prepare a material for a specific application. For example, in an application of formaldehyde adsorption, a porous material with a corresponding function may be independently selected as the mesoporous carbon, so as to accelerate the adsorption and decomposition of the formaldehyde. For another example, in an application of wastewater treatment, the attapulgite may be used as the porous core to quickly absorb organic matter in black-odor water, and speed up the purification of the black-odor water.

The method in the present disclosure is simple and easy to operate, does not need high requirements on equipment and technology, and has low product cost. The shell-core structure photocatalytic material has a strong adsorption capacity due to the porous structure, which may effectively improve the photocatalytic activity of titanium oxide, and may be widely used in dye wastewater treatment, air purification, anti-bacterial, odor-resistant, self-cleaning, anti-ultraviolet and other fields.

Example 1: preparation of a photocatalytic material with an activated carbon core and a titanium oxide shell.
1) 5 g of metatitanic acid (TiO(OH)₂) was added into 20 ml of concentrated sulfuric acid, and was thoroughly stirred for 2 hours to produce titanyl sulfate (TiOSO₄). 20 ml of distilled water was added to dissolve the titanyl sulfate completely.
2) After another 30 min of agitation, 5 g of activated carbon was added into the obtained solution above, and was thoroughly stirred for 2 hours to produce a suspension. 20 ml of ammonia water was slowly and dropwise added into the suspension until pH was about 4 to 5. After 4 hours of agitation, a gray precipitate was produced.
3) The gray precipitate was washed three times with water to obtain a filter cake, and the filter cake was annealed and dried at a temperature of 550° C. for 2 h.
4) The dried precipitate was ground to obtain powders of the photocatalytic material with the activated carbon core and the titanium oxide shell.

The parameters of the prepared material are shown in Table 1 below.

TABLE 1

| property | |
|---|---|
| specific surface area (m²/g) | 521 |
| pore volume (cm³/g) | 0.32 |
| pore diameter (nm) | 2.3 |
| crystal type | anatase |

Example 2: preparation of a photocatalytic material with a zeolite powder core and a titanium oxide shell.
1) 5 g of metatitanic acid (TiO(OH)₂) was added into 20 ml of concentrated sulfuric acid, and was thoroughly stirred for 2 hours to produce titanyl sulfate (TiOSO₄). 20 ml of distilled water was added to dissolve the titanyl sulfate completely.
2) After another 30 min of agitation, 5 g of zeolite powder was added into the obtained solution above, and was thoroughly stirred for 2 hours to produce a suspension. 20 ml of ammonia water was slowly and dropwise added into the suspension until pH was about 4 to 5. After 4 hours of agitation, a white precipitate was produced.
3) The white precipitate was washed three times with water to obtain a filter cake, and the filter cake was annealed and dried at a temperature of 400° C. for 4 h.
4) The dried precipitate was ground to obtain powders of the photocatalytic material with the zeolite powder core and the titanium oxide shell.

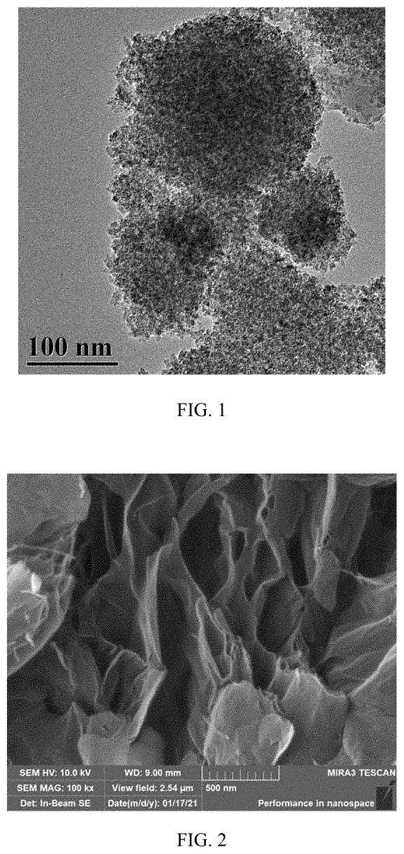

The parameters of the prepared material are shown in Table 2 below, and its scanning electron microscope image is shown in FIG. 1.

TABLE 2

| property | |
|---|---|
| specific surface area (m²/g) | 253 |
| pore volume (cm³/g) | 0.39 |
| pore diameter (nm) | 1.5 |
| crystal type | anatase |

Example 3: preparation of a photocatalytic material with an attapulgite core and a titanium oxide shell.
1) 5 g of metatitanic acid (TiO(OH)₂) was added into 20 ml of concentrated sulfuric acid, and was thoroughly stirred for 2 hours to produce titanyl sulfate (TiOSO₄). 20 ml of distilled water was added to dissolve the titanyl sulfate completely.
2) After another 30 min of agitation, 5 g of attapulgite was added into the obtained solution above, and was thoroughly stirred for 2 hours to produce a suspension. 20 ml of ammonia water was slowly and dropwise added into the suspension until pH was about 4 to 5. After 4 hours of agitation, a yellow precipitate was produced.
3) The yellow precipitate was washed three times with water to obtain a filter cake, and then the filter cake was annealed and dried at a temperature of 400° C. for 2 h.
4) The dried precipitate was ground to obtain powders of the photocatalytic material with the attapulgite core and the titanium oxide shell.

The parameters of the prepared material are shown in Table 3 below.

TABLE 3

| property | |
|---|---|
| specific surface area (m²/g) | 178 |
| pore volume (cm³/g) | 0.23 |
| pore diameter (nm) | 2.8 |
| crystal type | anatase |

Example 4: preparation of a photocatalytic material with a mesoporous silicon core and a titanium oxide shell
1) 5 g of metatitanic acid (TiO(OH)₂) was added into 20 ml of concentrated sulfuric acid, and was thoroughly stirred for 2 hours to produce titanyl sulfate (TiOSO₄). 20 ml of distilled water was added to dissolve the titanyl sulfate completely.
2) After another 30 min of agitation, 10 g of mesoporous silicon was added into the obtained solution above, and was thoroughly stirred for 2 hours to produce a suspension. 20 ml of sodium hydroxide was slowly and dropwise added into the suspension until pH was about 4 to 5. After 4 hours of agitation, a white precipitate was produced.
3) The white precipitate was washed three times with water to obtain a filter cake, and the filter cake was annealed and dried at a temperature of 600° C. for 2 h.
4) The dried precipitate was ground to obtain powders of the photocatalytic material with the mesoporous silicon core and the titanium oxide shell.

The parameters of the prepared material are shown in Table 4 below.

TABLE 4

| property | |
|---|---|
| specific surface area (m²/g) | 235 |
| pore volume (cm³/g) | 0.22 |
| pore diameter (nm) | 1.6 |
| crystal type | anatase |

Example 5: preparation of a photocatalytic material with a graphene core and a titanium oxide shell
1) 5 g of metatitanic acid (TiO(OH)₂) was added into 20 ml of concentrated sulfuric acid, and was thoroughly stirred for 2 hours to produce titanyl sulfate (TiOSO₄). 20 ml of distilled water was added to dissolve the titanyl sulfate completely.
2) After another 30 min of agitation, 5 g of graphene was added into the obtained solution above, and was thoroughly stirred for 2 hours to produce a suspension. 20 ml of sodium hydroxide was slowly and dropwise added into the suspension until pH was about 4 to 5. After 4 hours of agitation, a black precipitate was produced.
3) The black precipitate was washed three times with water to obtain a filter cake, and the filter cake was annealed and dried at a temperature of 600° C. for 2 h.
4) The dried precipitate was ground to obtain powders of the photocatalytic material with the mesoporous silicon core and the titanium oxide shell.

The parameters of the prepared material are shown in Table 5 below, and its scanning electron microscope image is shown in FIG. 2.

TABLE 5

| property | |
|---|---|
| specific surface area (m²/g) | 178 |
| pore volume (cm³/g) | 0.36 |
| pore diameter (nm) | 1.1 |
| crystal type | anatase |

Example 6: visible-light driven photocatalytic activity of a photocatalytic material with a graphene core and a titanium oxide shell
1) 50 ml of 20 ppm Rhodamine B solution and 50 mg of the photocatalytic material with the graphene core and the titanium oxide shell were added in a beaker and stirred well for 60 min to reach adsorption equilibrium.
2) A 300 W xenon lamp with a 420 nm filter was used as a visible light source and was placed 15 cm above the beaker. Samples were taken every 10 minutes.
3) Each sample was centrifuged to obtain supernatant, and ultraviolet-visible light absorbance spectrum of the supernatant was tested to obtain the visible light degradation data.

In the present disclosure, a photocatalytic activity of a material is indicated by a degradation rate of Rhodamine B, which can be indicated by C/C₀, where C represents a concentration of Rhodamine B to be detected and C₀ represents a concentration of Rhodamine B under the adsorption equilibrium. According to Beer's law, A=KC, where A represents an absorbance, K represents an absorbance coefficient, and C represents a concentration of a material to be detected, the degradation rate C/C₀ can be represented by A/A₀, where A₀ represents an absorbance at the adsorption equilibrium. The absorbance is acquired from the spectrum.

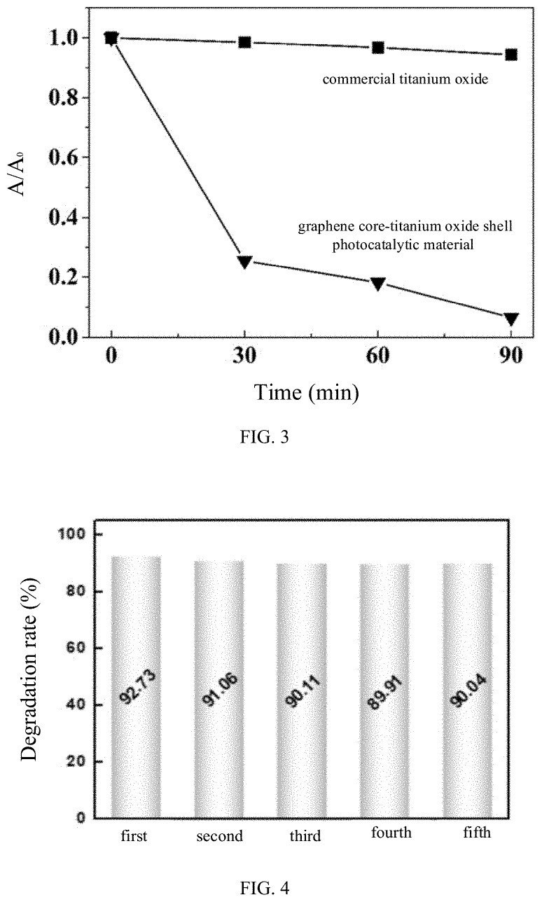

FIG. 3 compares a visible-light driven photocatalytic activity of a photocatalytic material with a graphene core and a titanium oxide shell prepared according to the present method and a photocatalytic activity of a commercial titanium oxide. It can be seen from FIG. 3 that with the present photocatalytic material, the degradation of Rhodamine B happens quickly and a high degradation rate is achieved.

FIG. 4 shows a stability of the visible-light driven photocatalytic activity of the present photocatalytic material with the graphene core and the titanium oxide shell. The photocatalytic material is used as a catalyst for the degradation of Rhodamine B for five times, and for each time, a high degradation rate is achieved, indicating a high stability of the photocatalytic material.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A method for preparing a core-shell structure photocatalytic material, comprising:
obtaining a titanyl sulfate solution by mixing and reacting sulfuric acid and metatitanic acid, wherein the metatitanic acid is used as a titanium source, and a first reaction formula is indicated by:
H₂TiO₃+H₂SO₄→TiOSO₄+2H₂O;
obtaining a mixed solution by adding a porous material into the titanyl sulfate solution, wherein the porous material has a hydrophilic surface to allow the titanyl sulfate solution to diffuse into pores of the porous material to obtain a porous composite material coated with the titanyl sulfate, and a second reaction formula is indicated by:
TiOSO₄+porous material→titanyl sulfate porous composite material;
adding an alkali into the mixed solution to obtain a precipitation product by reacting the alkali with the titanyl sulfate coated on the surface of the porous material, wherein a third reaction formula is indicated by:
TiOSO₄+alkali→TiO(OH)₂↓+sulfate;
filtering, washing, drying and calcining the precipitation product to obtaining a core-shell structure photocatalytic material with the porous material as a core and a mesoporous quantum titanium oxide as a shell, wherein a fourth reaction formula is indicated by:

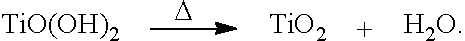

2. The method according to claim 1, wherein the metatitanic acid is from a raw material having a mass fraction of the metatitanic acid in a range of 40% to 50%, and has a relative molecular mass of 97.92.

3. The method according to claim 1, wherein the sulfuric acid has a density of 1.84 g/mL, and a relative molecular mass of 98.

4. The method according to claim 1, wherein a molar mass ratio of the metatitanic acid to the sulfuric acid is in a range of 1:1 to 1:10.

5. The method according to claim 1, wherein a mixing time of the metatitanic acid and the sulfuric acid is in a range of 0.1 to 24 hours.

6. The method according to claim 1, wherein a mass ratio of the titanyl sulfate to the porous material is in a range of 1:1 to 1:1000.

7. The method according to claim 1, wherein a mixing time of the titanyl sulfate and the porous material is in a range of 0.1 to 24 hours.

8. The method according to claim 1, wherein a diffusion depth of the titanyl sulfate in the porous material is in a range of 1 to 2 μm.

9. The method according to claim 1, wherein the titanyl sulfate diffuses into the porous material at a temperature of 80 to 400° C. with a heating rate of 2 to 10° C./min, and at a pressure of 0 to 30 bar.

10. The method according to claim 1, wherein a mass ratio of the alkali to the titanyl sulfate is in a range of 1:1 to 1:10.

11. The method according to claim 1, wherein a mixing time of the titanyl sulfate and the alkali is in a range of 0.1 to 24 hours.

12. The method according to claim 1, wherein the alkali is selected from ammonia water, sodium hydroxide, calcium hydroxide, ferric hydroxide, potassium hydroxide, sodium bicarbonate, sodium carbonate, zinc hydroxide, aluminum hydroxide, ferrous hydroxide, magnesium hydroxide, cobalt hydroxide, gold hydroxide, copper hydroxide, beryllium hydroxide, and a combination thereof.

13. The method according to claim 1, wherein the porous material is selected from zeolite powders, molecular sieve, activated carbon, porous aluminum oxide, mesoporous silicon oxide, mesoporous carbon, mesoporous silicon, carbon black, attapulgite, bentonite, diatomaceous earth, three-dimensional graphene, metal organic framework materials, covalent organic framework materials, two-dimensional metal carbides or nitrides, and a combination thereof.

14. The method according to claim 1, wherein the porous material has a pore diameter of 2 to 20 nm, a surface contact angle not greater than 30°, a specific surface area not less than 150 m²/g and a pore volume not less than 0.1 cm³/g.

15. The method according to claim 1, wherein the mesoporous quantum titanium oxide is generated at a temperature of 60 to 1200° C. with a heating rate of 2 to 20° C./min.

16. The method according to claim 1, wherein the mesoporous quantum titanium oxide is a titanium oxide nanoparticle with a size of 1 to 10 nm, and has a porous structure with a pore diameter of 0.1 to 2 nm.

17. The method according to claim 1, wherein the mesoporous quantum titanium oxide has a specific surface area in a range of 150 to 300 m²/g.

18. The method according to claim 1, wherein the mesoporous quantum titanium oxide has a crystal type selected from anatase, rutile, and rutile-doped anatase.

19. The method according to claim 1, wherein the mesoporous quantum titanium oxide has a size in a range of 3 to 5 nm, and a pore diameter in a range of 0.3 to 2 nm.

20. The method according to claim 1, wherein the photocatalytic material has a specific surface area of 100 to 600 m²/g, a pore diameter in a range of 1 to 3 nm, and a pore volume of 0.1 to 2 cm³/g.
